(19) United States
(12) Patent Application Publication
(10) Pub. No.: US 2010/0313333 A1
(43) Pub. Date: Dec. 16, 2010

(54) IMPRINTED GLOVE, AND METHOD OF MANUFACTURE AND SALE THEREOF

(76) Inventor: Jaidev Khanna, Mississauga (CA)

Correspondence Address: GIFFORD, KRASS, SPRINKLE,ANDERSON & CITKOWSKI, P.C, PO BOX 7021, TROY, MI, 48007-7021, US

(21) Appl. No.: 12/792,101

(22) Filed: Jun. 2, 2010

Related U.S. Application Data
(60) Provisional application No. 61/185,633, filed on Jun. 10, 2009.

(51) Int. Cl. A41D 19/00; B32B 7/08; G06Q 90/00

(52) U.S. Cl. 2/162; 156/93; 705/500; 112/475.09

(57) ABSTRACT

A marking method for use with a glove and an image is disclosed. The glove is of the type having a wrist flap closure. The marking method comprises the steps of: providing said image on a surface of an image carrier defined by a pliable sheet material, the surface having a predefined size and shape; and stitching the image-carrier on the wrist flap closure of said glove. Gloves produced by the method, and business methods employing the method are also disclosed.

### CROSS-REFERENCE TO RELATED APPLICATION

This application claims priority of U.S. Provisional Patent Application Ser. No. 61/185,633 filed Jun. 10, 2009, which is incorporated herein by reference.

### FIELD OF THE INVENTION

The present invention relates to the field of sport.

### BACKGROUND OF THE INVENTION

It is well-known to imprint logos or the like on clothing articles or sporting equipment. Golf balls, for example, are commonly imprinted with corporate logos, and given to clients for promotional purposes. Historically, these have been quite popular, as they can be imprinted relatively inexpensively, and are usually welcomed by clients. Unfortunately, the imprinting area available is relatively small. As well, the novelty associated with a logo-imprinted ball has long ago been lost. Other articles, such as shirts, are also warmly received, and these have the advantage of relatively large imprinting areas, but shirts are relatively costly as a give-away item. There exists an ongoing need for relatively inexpensive goods which can be imprinted upon relatively economically and which provide a relatively large messaging area.

### SUMMARY OF THE INVENTION

A marking method forms one aspect of the invention. The marking method is for use with a glove and an image. The glove is of the type having a wrist flap closure, such as a golf glove. The marking method comprises the steps of: providing said image on a surface of an image carrier defined by a pliable sheet material, the surface having a predefined size and shape; and stitching the image-carrier on the wrist flap closure of said glove.

According to another aspect of the invention, the providing step can comprise the substeps of: printing said image on a film; and adhesively securing the film to a substrate.

According to another aspect of the invention, said image can be digitally printed on the film using an electronic file representative of said image.

According to another aspect of the invention, said image can be printed so as to be indelible and the image carrier can be a leather-like material.

According to another aspect of the invention, the film can have an adhesive backing via which the film is adhesively secured to the substrate.

According to another aspect of the invention, said image can be printed on a two-layer material which consists of the film and a release liner to which the film is releasably adhesively secured by the adhesive layer.

According to another aspect of the invention, the printing substep can be a printing and die-cutting operation, and the die-cutting can be carried out such that, at the completion of the printing and die-cutting operation, the release liner remains intact and said image is imprinted on a film cut-out having the predefined size and shape.

According to another aspect of the invention, in the adhesive securement substep, a cut-out can be removed from the release liner and positioned in registry with a blank of the substrate having a receiving surface for receiving the adhesive backing of the film, which receiving surface is of the predefined size and shape.

According to another aspect of the invention, the predefined size and shape can be generally that of an equilateral tetragon, with rounded corners and sides which are each about 3.6 cm in length.

According to another aspect of the invention, the image carrier can be stitched about its periphery to the glove, the stitching being laid within 2 mm of the edge of the image carrier.

Gloves marked by the marking methods of the present invention form yet other aspects of the invention.

A business method forms yet another aspect of the invention. The business method comprises the steps of: receiving or creating an electronic file representative of an image; carrying out a marking method according to the invention with the image to produce a marked glove bearing the image; packaging the marked glove in a cardstock envelope, the envelope having a label receiving area; printing the image on a self-adhesive label; and securing the label on the label receiving area.

According to another aspect of the invention, the cardstock envelope can have on one side a pair of apertures for viewing the marked glove, the pair of apertures being separated by a horizontal bar which defines the label receiving area.

The present invention facilitates the provision of a relatively inexpensive good which can be imprinted-upon relatively economically in a manner which provides a relatively large messaging area. Other advantages, features and characteristics of the present invention, will become apparent upon consideration of the following detailed description and the appended claims with reference to the accompanying drawings and photographs, the latter being briefly described hereinafter.

### BRIEF DESCRIPTION OF THE FIGURES

FIG. 1 is a schematic flow diagram of a marking method according to the present invention;

FIG. 2 is a view of an exemplary glove produced according to an exemplary embodiment of the invention; and

FIG. 3 is a view of the structure of FIG. 2, packaged for sale.

### DETAILED DESCRIPTION

The present invention relates to a method for marking gloves, gloves so marked, and an associated business method.

The marking method is for use with gloves, each of the type having a wrist flap closure, i.e. golf gloves.

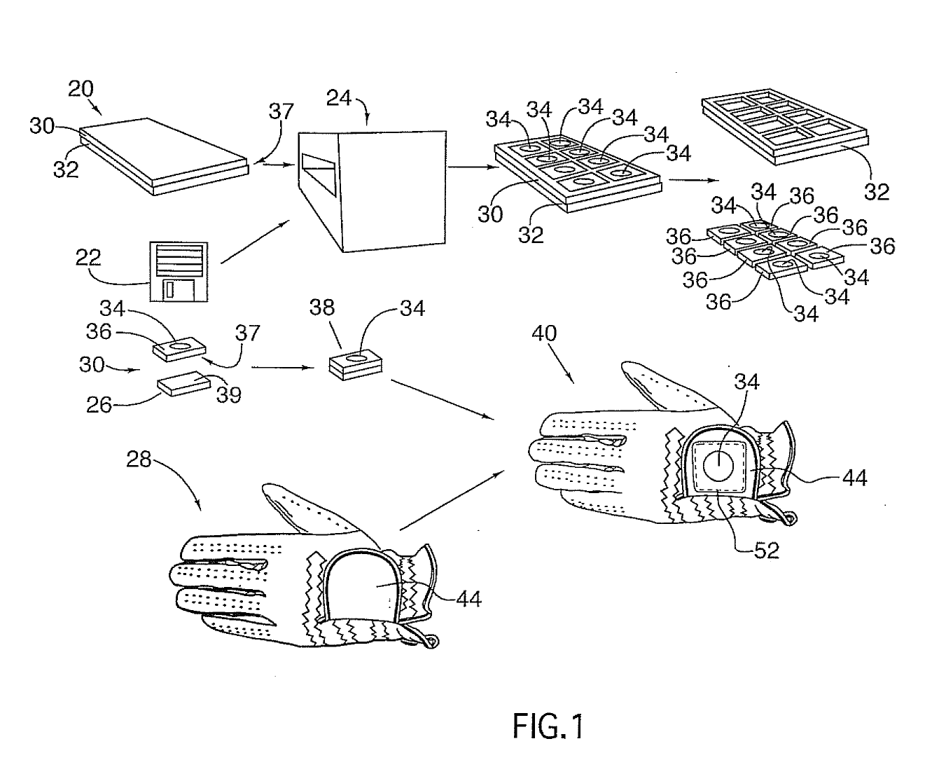

An exemplary embodiment of the method utilizes a two-layer material 20, an electronic file 22, a printing-and-punching machine 24, a blank 26 and a glove 28, all as indicated schematically in FIG. 1.

The two-layer material 20 consists of a film layer 30 and a release liner 32. The film 3D has an adhesive backing 37 via which the film 30 is adhesively releasably secured to the release liner 32. In the exemplary embodiment, the two-layer material 20 is that sold by ORAFOL EUROPE GMBH under the trade-mark Orajet.

The electronic file 22 is representative of an image and is shown schematically as a floppy disk, but it will be understood that this is for ease of illustration, only. The printing-and-punching machine 24 receives the electronic file 22 and the two-layer material 20 and carries out a printing and die-cutting operation. As part of this operation, a plurality of images 34 are indelibly digitally printed on the film 30 using the electronic file 22. In the die-cutting part of the operation, the film layer 30 is selectively die cut, leaving the release liner 32 intact. At the completion of the printing and die-cutting operation, each of the images 34 is imprinted on a film cut-out 36 having a predefined size and shape. In this exemplary embodiment, the predefined size and shape is that of an equilateral tetragon, with rounded corners and sides which are each about 3.6 cm in length.

In FIG. 1, the images 34 will be seen to be a simple circle. However, this is for ease of illustration, only, and it should be understood that any image capable of digital reproduction, for example, pictures, corporate logos, etc., can be utilized.

The blanks 26 are a leather-like material, each have a receiving surface 39, also of the predefined size and shape, for receiving in registry [i.e. aligned, overlapping relation] the adhesive backing 37 of a respective one of the cut-outs 36, after removal of that cut-out 36 from the release liner 32.

The adhered combination of the film cut-out 36 and blank 26 defines an image carrier 38 in the form of a leather-like material, i.e. a pliable sheet, on which the image 34 is provided.

To complete the marking method, the image-carrier 38 is stitched onto the wrist flap closure 44 of said glove 28, to produce a marked glove 40.

As will be noted, the illustrations show a plurality of cut-outs 36. This is not necessary, but normally, a plurality of gloves bearing the same image will be produced, and each of these cut-outs 36 would be expected to be secured to a respective blank 26 and then stitched to a respective glove 28.

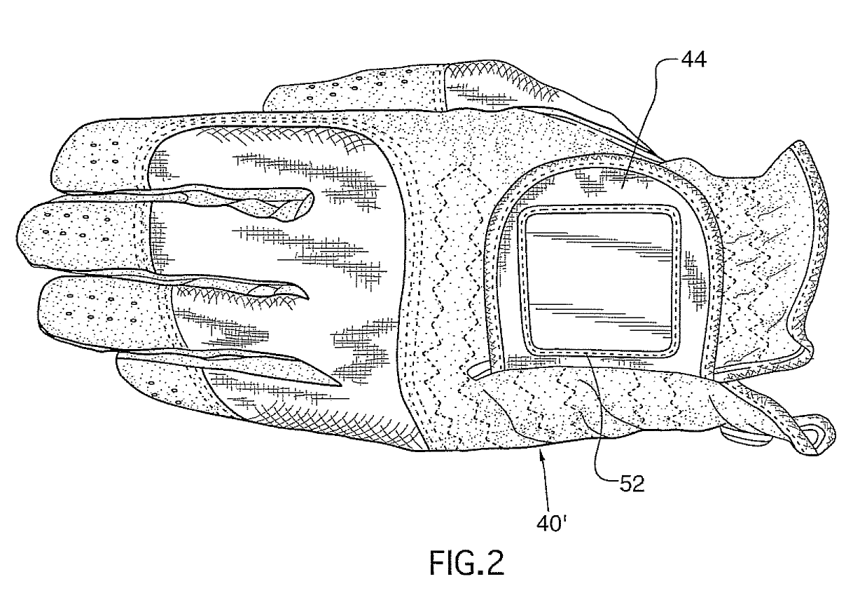

FIG. 2 is a view of an exemplary glove 40′ produced according to the process, wherein it can be seen that the image carrier is stitched about its periphery to the glove. The stitching 52 is laid within 2 mm of the edge of the image carrier and is effected in a thread which is of the same color as the border.

Gloves marked by the marking method(s) of the present invention form yet other aspects of the invention.

The inventive marking method is usefully employed as part of a business method which forms yet another aspect of the invention.

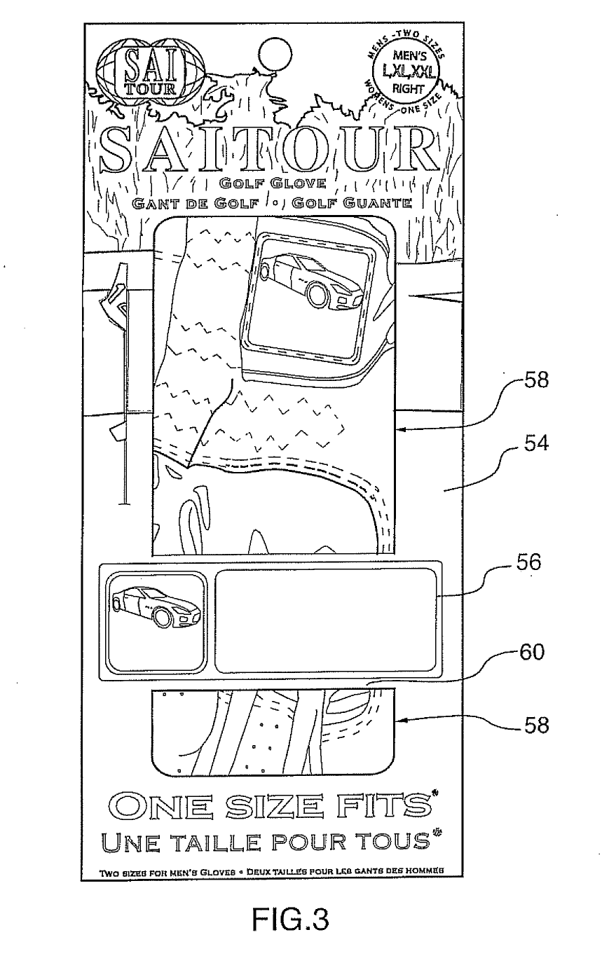

In the business method, an electronic file representative of an image is received from a customer. For example, the pro shop at a golf course might provide an electronic image of its signature hole. Thereafter, the marking method is carried out with the image a number of times, to provide a supply of marked gloves bearing the image. As well, a plurality of self-adhesive labels are printed. Each label also bears the image, the image being presented in the same size as on the cut-outs. Thereafter, with reference to FIG. 3, the marked gloves are each packaged in a cardstock envelope 54, and a label 56 is secured to the envelope 54. The envelope 54 will be seen to have a pair of apertures 58 for viewing the package contents, these apertures 58 being separated by a horizontal bar 60 which defines the label-receiving surface.

The glove shown in FIG. 2 is of the “one size” type, i.e. stretchable, so as to accommodate a large range of hand sizes, and provided for both left and right hands.

The inventive marking method makes it possible for a supplier to make available, in relatively small production runs and short turn-around times, and on a relatively inexpensive basis, gloves, such as golf gloves, personalized with images such as photographs or the like, with relatively high presentation value, i.e. gloves which do not appear to be cheaply or poorly made. The inventive package adds yet further to the presentation value. When the above is employed in combination with gloves which accommodate a large range of hand sizes, the value of the product for distribution [both give-away and sale] purposes increases. [For example, if t-shirts were being given away as a promotional item at a charity golf tournament, the organizers would normally order a range of sizes, based on assumptions as to the expected size of the attendees, and would likely order extras, to account for assumption errors; in contrast, in a one-size-fits-all case, such a golf balls, no spares are required.] The inventive method allows for the operation of a business that meets a wide variety of heretofore unsatisfied relatively-small-volume needs, including but not limited to: corporate promotions; souvenirs; wedding favors and other commemorative gifts.

It is to be understood that while but several embodiments of the present invention have been herein shown and described, various changes in size and shape of parts, and process steps, may be made, without departing from the spirit or scope of the invention, which is accordingly limited only by the claims appended hereto, purposively construed.

1. A marking method for use with a glove and an image, the glove being of the type having a wrist flap closure, the marking method comprising the steps of:
providing said image on a surface of an image carrier defined by a pliable sheet material, the surface having a predefined size and shape; and
stitching the image-carrier on the wrist flap closure of said glove.

2. A marking method according to claim 1, wherein the providing step comprises the substeps of:
printing said image on a film; and
adhesively securing the film to a substrate.

3. A marking method according to claim 2, wherein said image is digitally printed on the film using an electronic file representative of said image.

4. A marking method according to claim 3, wherein said image is printed so as to be indelible and the image carrier is a leather-like material.

5. A marking method according to claim 4, wherein the film has an adhesive backing via which the film is adhesively secured to the substrate.

6. A marking method according to claim 5, wherein said image is printed on a two-layer material which consists of the film and a release liner to which the film is releasably adhesively secured by the adhesive layer.

7. A marking method according to claim 6, wherein the printing substep is a printing and die-cutting operation, the die-cutting being carried out such that, at the completion of the printing and die-cutting operation, the release liner remains intact and said image is imprinted on a film cut-out having the predefined size and shape.

8. A marking method according to claim 7, wherein, in the adhesive securement substep, a cut-out is removed from the release liner and positioned in registry with a blank of the substrate having a receiving surface for receiving the adhesive backing of the film which receiving surface is of the predefined size and shape.

9. A marking method according to claim 1, wherein the predefined size and shape is generally that of an equilateral tetragon, with rounded corners and sides which are each about 3.6 cm in length.

10. A marking method according to claim 9, wherein the image carrier is stitched about its periphery to the glove, the stitching being laid within 2 mm of the edge of the image carrier.

11. A glove marked by the marking method of claim 1.

12. A business method comprising the steps of:
receiving or creating an electronic file representative of an image;
carrying out the marking method of claim 3 with the image to produce a marked glove bearing the image;
packaging the marked glove in a cardstock envelope, the envelope having a label receiving area;
printing the image on a self-adhesive label; and
securing the label on the label receiving area.

13. A business method according to claim 12, wherein the cardstock envelope has on one side a pair of apertures for viewing the marked glove, the pair of apertures being separated by a horizontal bar which defines the label receiving area.

14. A business method according to claim 13, wherein the image is printed so as to be indelible and the image carrier is a leather-like material.

15. A business method according to claim 14, wherein the film has an adhesive backing via which the film is adhesively secured to the substrate.

16. A business method according to claim 15, wherein the image is printed on a two-layer material which consists of the film and a release liner to which the film is releasably adhesively secured.

17. A business method according to claim 16, wherein the printing substep is a printing and die-cutting operation, the die-cutting being carried out such that, at the completion of the printing and die-cutting operation, the release liner remains intact and the image is imprinted on a respective film cut-out having the predefined size and shape.

18. A business method according to claim 17, wherein, in the adhesive securement substep, a cut-out is removed from the release liner and positioned in registry with a blank of the substrate having a receiving surface for receiving the adhesive backing of the film, which receiving surface is of the predefined size and shape.

19. A business method according to claim 18, wherein the predefined size and shape is generally that of an equilateral tetragon, with rounded corners and sides which are each about 3.6 cm in length.

20. A business method according to claim 19, wherein the image carrier is stitched about its periphery to the glove, the stitching being laid within 2 mm of the edge of the image carrier.

21. A business method according to claim 12, wherein the glove is designed to accommodate a large range of hand sizes.
